(19) United States
(12) Patent Application Publication
(10) Pub. No.: US 2009/0271228 A1
(43) Pub. Date: Oct. 29, 2009

(54) CONSTRUCTION OF PREDICTIVE USER PROFILES FOR ADVERTISING

(75) Inventors: Mikhail Bilenko, Bellevue, WA (US); Ryen William White, Kirkland, WA (US); Matthew Richardson, Seattle, WA (US); Geoffrey Craig Murray, Bethesda, MD (US); Projesh Chowdhary, Redmond, WA (US); Hrishikesh Bal, Bellevue, WA (US); Gerard Gjonej, Seattle, WA (US); John S. Sobieski, Redmond, WA (US); JianBing Li, Redmond, WA (US); Ewa Dominowska, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/107,767

(22) Filed: Apr. 23, 2008

(51) Int. Cl. G06Q 30/00; G06Q 10/00

(52) U.S. Cl. 705/7

(57) ABSTRACT

A system that facilitates targeted advertising is described in detail herein. The system includes a receiver component that receives user data that includes historical searching and browsing activity of a user. A profile generator component generates a user profile based at least in part upon a subset of the user data, wherein the user profile includes a plurality of keywords, wherein at least one keyword in the plurality of keywords is assigned a score that is indicative of a probability that an advertisement corresponding to the keyword will be monetized.

### BACKGROUND

An incredible amount of information is accessible to individuals who have access to a networked device. Pursuant to an example, a user can search for a particular topic by proffering a search query to a search engine. The search engine, utilizing the proffered query, can locate and rank numerous web pages and provide such pages to the user. Therefore, for instance, a web page deemed most relevant to the user (given the proffered query) will be displayed most prominently to the user, while other less relevant pages will be displayed less prominently.

Along with facilitating location of information, the Internet is being used for generation of revenue. For instance, a retailer can create a website that is designed for the sale of goods and services offered by the retailer. In addition, websites exist that are dedicated to auctioning goods and/or services offered by retailers and/or individuals. Oftentimes, consumers prefer purchasing items online, as they can avoid hassles associated with driving to shopping centers.

Another manner in which the Internet has been used to generate revenue is through sale of advertisements that are displayed on web pages. For instance, when a user proffers a query to a search engine, contents of the query can be made available to prospective advertisers. The advertisers purchase space on a web page that shows search results based at least in part upon contents of the query. For instance, if the user searches for “digital camera”, a retailer that sells digital cameras may wish to provide an advertisement to the user in hopes that the user will purchase a digital camera from the retailer. Revenue can be generated by the search engine, for instance, if the user selects the advertisement. Web pages can also sell space to advertisers to generate revenue for the owner of the web page. Conventionally, online advertising relies on immediate context for selecting relevant advertisements to display to users. Immediate context may include a current search query, queries proffered by a user in a single session, and page content of a web page where an advertisement is displayed.

### SUMMARY

The following is a brief summary of subject matter that is described in greater detail herein. This summary is not intended to be limiting as to the scope of the claims.

Various technologies pertaining to targeted advertising are described herein. More particularly, generation of a user profile (that is customized for a user based upon previous behaviour) for utilization in connection with targeting advertisements to a user is described herein. The user profile may include numerous keywords, wherein each of the keywords may optionally be assigned a score or a plurality of scores. In an example, a score assigned to a keyword may be indicative of a probability that an advertisement corresponding to the keyword will be monetized by the user. For instance, the probability may relate to a probability that the user will select an advertisement that is served to the user, wherein an advertiser serves the advertisement based at least in part upon a keyword in the user profile.

As noted above, the user profile may be generated based upon previous user behaviour, such as behaviour that can be ascertained from search engine logs, queries proffered by a user, web pages visited by the user, advertisements selected by the user, amongst other data. A first set of keywords (e.g., a word or a collection of words) can be extracted from the user behaviour data. Thereafter, keywords that are related to the first set of keywords can be automatically ascertained. Pursuant to an example, machine-learning techniques can be utilized to determine the related keywords. The first set of keywords and the related keywords in combination can be referred to as a raw user profile.

A user profile that includes a plurality of keywords may then be generated based at least in part upon contents of the raw user profile. Pursuant to an example, machine learning techniques can be utilized in connection with generating the user profile, which includes selecting keywords to include in the user profile as well as individually assigning scores to keywords in the user profile. Once the user profile is created, advertisements can be served to a user based at least in part upon content of the user profile.

Other aspects will be appreciated upon reading and understanding the attached figures and description.

### BRIEF DESCRIPTION OF THE DRAWINGS

FIG. 1 is a functional block diagram of an example system that facilitates generating a user profile.

FIG. 2 is a functional block diagram of an example system that facilitates generating a user profile based at least in part upon log data.

FIG. 3 is a functional block diagram of an example system that facilitates tracking activity of a user.

FIG. 4 is a functional block diagram of an example system that facilitates serving an advertisement to a user based at least in part upon a user profile.

FIG. 5 is a functional block diagram of an example system that facilitates updating an existing user profile based at least in part upon recent user activity.

FIG. 6 is a functional block diagram of an example system that facilitates generation of a function that can be used in connection with generating a user profile.

FIG. 7 is flow diagram that illustrates an example methodology for generating a user profile.

FIGS. 8 and 9 depict a flow diagram that illustrates an example methodology for generating a user profile.

FIG. 10 is a flow diagram that illustrates an example methodology for serving an advertisement to a user based at least in part upon a user profile.

FIG. 11 is a flow diagram that illustrates an example methodology for setting a price for a keyword.

FIG. 12 is an example computing system.

### DETAILED DESCRIPTION

Various technologies pertaining to generating a user profile that can be employed in connection with targeted advertising will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

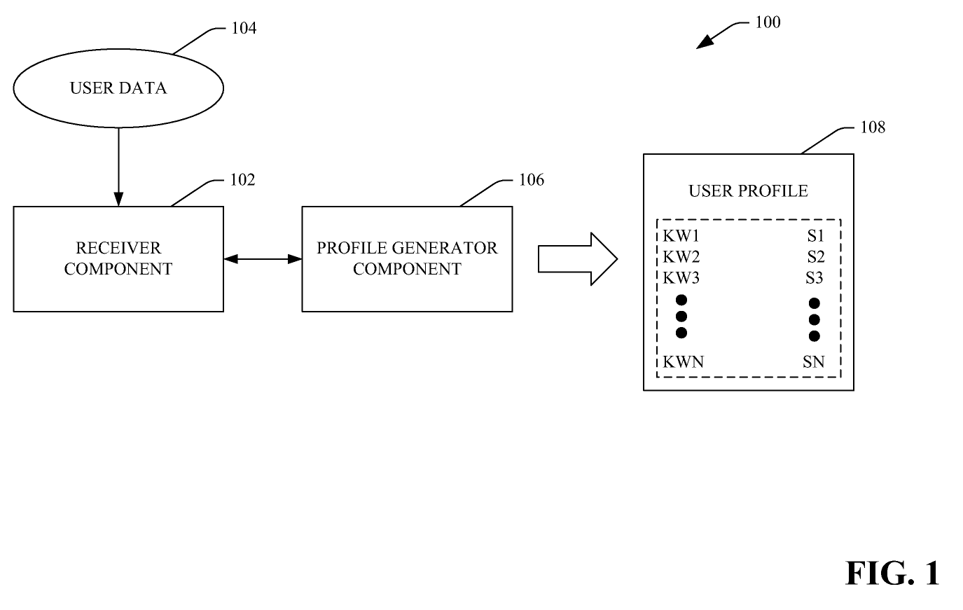

With reference to FIG. 1, an example system 100 that facilitates generating a user profile for employment in targeted advertising is illustrated. The system 100 includes a receiver component 102 that receives user data 104 that pertains to a particular user. The user data 104 may include logs of user behavior, which may include search queries, web page views, selections of advertisements, amongst other data. The user data 104 may further include, for example, views of certain television programs, ratings provided to media selections (e.g., songs, movies, . . . ), current content of a hard drive, geographic location of a user when the user is viewing certain web pages and/or proffering queries, and other data that is user-specific. Moreover, the user data 104 may include data that is explicitly provided by the user, such as topics of interest to the user, products that the user is interested in purchasing, age of the user, gender of the user, amongst other data. Furthermore, one or more of the aforementioned attributes may be inferred based upon monitored user activities.

In still yet another example, the user data 104 may include off-line activity, such as location information received from position sensors, credit card purchase information, television viewing habits of the user, and/or other information. Additionally, the user data 104 may include online purchases of the user (e.g., identification of purchased items and/or services), time of day that a query was proffered to a search engine, data pertaining to music reviewed and/or listened to by the user, contextual data corresponding to online activity, etc.

A profile generator component 106 can receive a subset of data from the user data 104 and can generate a user profile 108 based at least in part upon the subset of data from the user data 104. The user profile 108 includes a plurality of keywords, wherein each of the keywords may individually be assigned a score or scores. A keyword may be a single word or a plurality of words and/or characters in a certain sequence. In an example, a score that is assigned to a keyword can be indicative of a probability that an advertisement corresponding to the keyboard will be monetized. As used herein, the term “monetized” may mean realization of revenue by any suitable manner, such as receiving payment upon a user clicking upon an advertisement, receiving payment for a keyword, and/or the like.

Pursuant to an example, a score assigned to a keyword in the user profile 108 can indicate a probability that the user will select an advertisement that is served by an advertiser in response to the keyword. In another example, a score assigned to a keyword in the user profile 108 may indicate revenue expected to be received from an advertiser who will place a bid on advertising space when the keyword is received. In yet another example, a score assigned to a keyword in the user profile 108 may be indicative of a probability that the user will be interested in topics corresponding to the keyword at some point in the future. The profile generator component 106 can be “tuned”, for instance, to assign scores based upon any one or combination of the aforementioned examples. Furthermore, the profile generator component 106 can infer keywords to include in the user profile 108 that are expected to be of interest to a user at a future point in time, wherein the profile generator component 106 infers the keywords based at least in part upon the user data 104. Generation of the user profile 108 will be described in greater detail below.

In a particular example, the user profile 108 may be limited to a threshold number of keywords. For instance, raw data logs may include several thousand keywords for any given user, and it may be computationally burdensome to search through advertisements submitted for each keyword in connection with advertisers purchasing advertising space on a graphical user interface. Thus, the user profile 108 may be compact and include a relatively small number of keywords. For instance, the user profile 108 may include five keywords. In another example, the user profile 108 may include twenty keywords. In yet another example, the user profile 108 may include five hundred keywords. A number of keywords in the user profile 108 may be dependent upon computational considerations, and may vary over time.

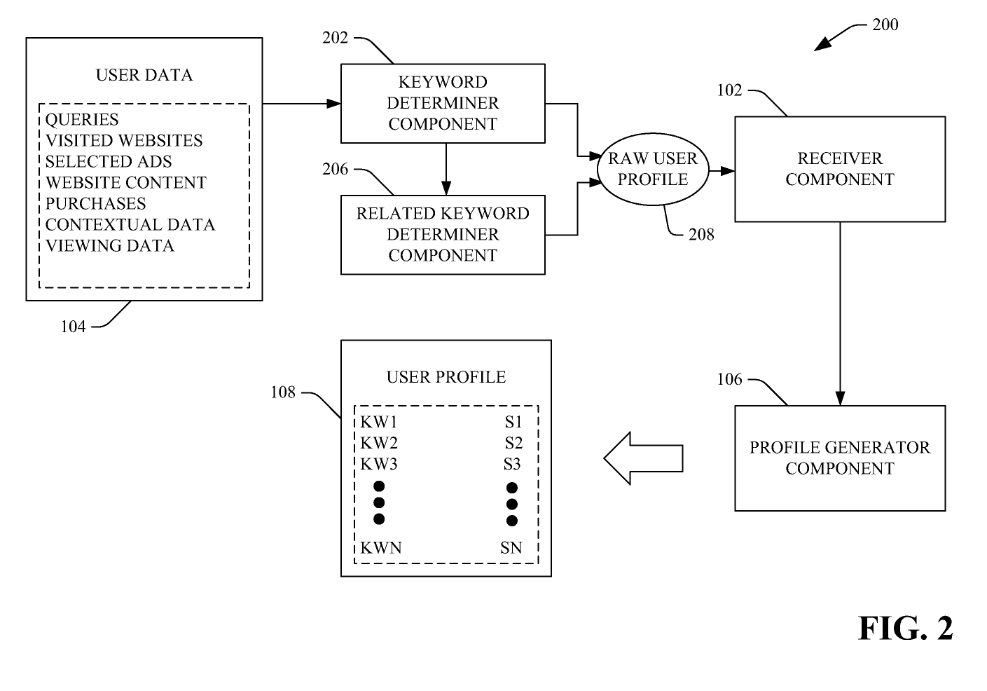

Referring now to FIG. 2, an example system 200 that facilitates generating a user profile for employment in connection with targeted advertising is illustrated. The system 200 includes a keyword determiner component 202 that receives the user data 104. The keyword determiner component 202 can output keywords that are based at least in part upon the user data 104. For instance, at least a portion of the user data 104 may not be in the form of keywords, and the keyword determiner component 202 can determine keywords for such portions. In an example, the user data 104 may include content of a web page, and the keyword determiner component 202 can determine keywords that are representative of such content. For instance, the keyword determiner component 202 can review metadata, such as tags, of a web page viewed by the user and can determine keywords for the web page based at least in part upon the reviewed metadata. In another example, a query in the user data 104 may include several words to create a phrase. The keyword determiner component 202 may parse the query and output one or more keywords based at least in part upon the parsed query. Accordingly, the keyword determiner component 202 can, upon receipt of the user data 104, output keywords that are representative of the content of the user data 104.

A related keyword determiner component 206 can receive keywords determined by the keyword determiner component 202 and can determine keywords that are related to the received keywords (related keywords). These related keywords may, for instance, better reflect a user's future interests than keywords from the user data 104. In an example, a keyword “tree” may be most suitable for a user whose search queries include “oak” and “pine”, even though the keyword “tree” was never proffered by the user as a query. The keyword determiner component 206 may use any suitable technique or combination of techniques to determine related keywords.

The receiver component 102 can receive keywords from the keyword determiner component 202 and/or related keywords from the related keyword determiner component 206. The combination of keywords determined from the user data 104 and keywords related thereto (as determined by the related keyword determiner component 206) can be referred to as a raw user profile 208. The profile generator component 106 receives the raw user profile 208 and generates the user profile 108 based at least in part upon contents of the raw user profile 208.

More specifically, the profile generator component 106 can generate the user profile 108 such that it includes a non-empty set of keywords, wherein each of the keywords may be individually assigned a score (or scores) that is indicative of, for instance, a measure of relevance of the keyword to the user. As noted above, a score assigned to a keyword may be indicative of a probability that an advertisement served in response to the keyword will be monetized (e.g., selected) by a user corresponding to the user profile 108. In another example, a score assigned to a keyword may be indicative of a probability that the user will be interested in a topic represented by the keyword at some point in the future.

The profile generator component 106 can consider a multitude of factors when generating the user profile 108 based at least in part upon keywords in the raw user profile 208. For instance, the profile generator component 106 can select a keyword to include in the user profile 108 based at least in part upon recency and/or frequency of occurrence of the keyword in the user data 104. In another example, the profile generator component 106 can select a keyword to include in the user profile 108 based at least in part upon monetization performance of advertisers/advertisements that bid on the keyword. In another example, the profile generator component 106 can select a keyword to include in the user profile 108 based at least in part upon demographic performance of the keyword. Other factors that may be considered by the profile generator component 106 include a representativeness of a keyword with respect to other keywords in the raw user profile, a likelihood that a keyword reflects user interests that will remain relevant in the future given past keyword occurrences, a propensity of a keyword to generate advertisements that the user is likely to select, amongst other factors. The profile generator component 106 may take into consideration one or more of the aforementioned factors (in any suitable combination) when generating the user profile 108.

The profile generator component 106 may quantify a factor by analyzing features of keywords. In an example, the profile generator component 106 may compute the following feature for each keyword in the raw user profile 208 to capture the frequency and recency of occurrences of the keyword in the user data 104, as well as those of related keywords:

$$\text{?}$$

$$\text{?} \text{indicates text missing or illegible when filed}$$

where t(oᵢ) represents a function that quantifies recency for every occurrence oᵢ of a given keyword kw, and w(kw, kw′) represents a similarity weight between the keyword kw and its neighbor kw′. An example function that penalizes recency is as follows:

t(oᵢ)=1−α log(NumberOfDaysSinceOccurrence(oᵢ)).

where α<1 is a constant.

Of course, the profile generator component 106 can compute other features that are constructed to quantify the aforementioned factors as well as other properties of keywords (or a user) that may be of interest, such as overall advertisement click-through probability.

As keywords can be associated with numerous features, it may be difficult to determine relative importance of features or manually construct a function that combines features into a single score that can be assigned to a keyword. Accordingly, the profile generator component 106 can use a machine-learned function/algorithm to select/generate keywords to be included in the user profile 108. Example machine learning techniques for generation of functions/algorithms that may be utilized by the profile generator component 106 are described in greater detail below.

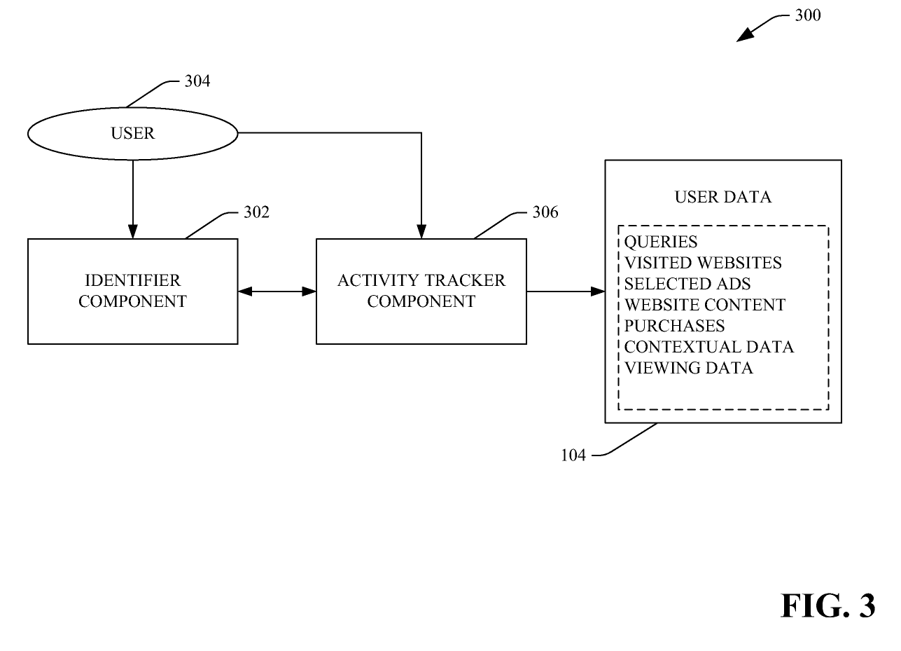

Now turning to FIG. 3, an example system 300 that facilitates collecting user data for utilization in connection with generating a user profile is illustrated. The system 300 includes an identifier component 302 that acts to identify a user 304. For instance, the identifier component 302 can identify the user 304 by an IP address, a log-in name, a computer name, cookies, biometric indicia (such as a fingerprint scan), etc. Once the identifier component 302 identifies the user 304, activity of the user can be tracked and stored as the user data 104. More specifically, an activity tracker component 306 may be employed to generate logs of online activity of the user 304. As noted above, these logs may be used in connection with generating a raw user profile, which may in turn be employed in connection with generating a user profile for utilization with respect to targeted advertising.

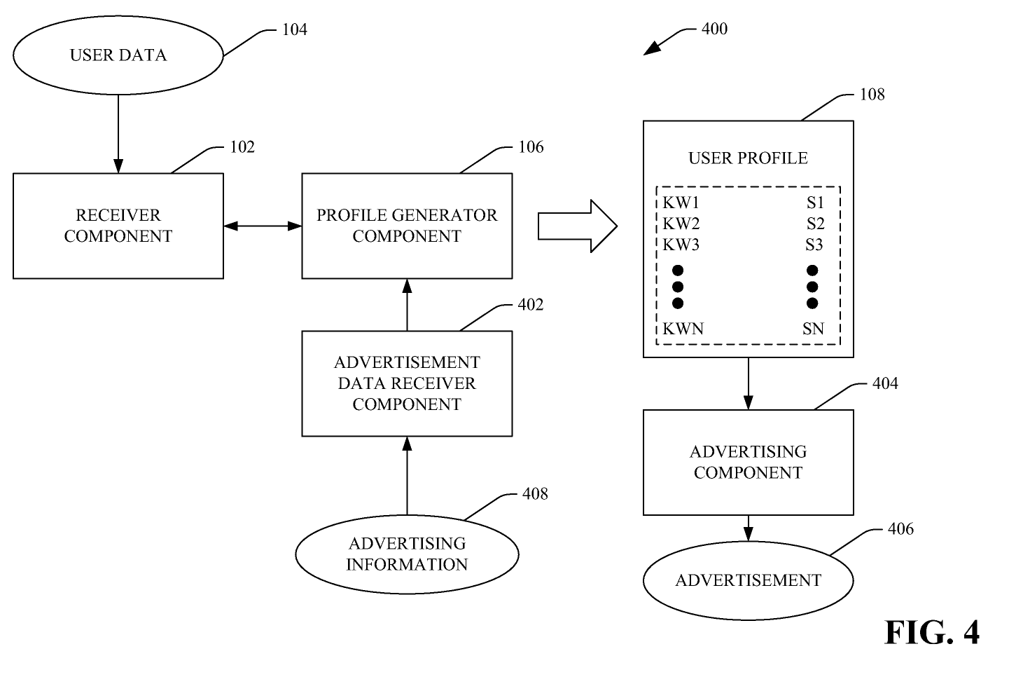

With reference now to FIG. 4, an example system 400 that facilitates providing a targeted advertisement to a user is illustrated. The system 400 includes the receiver component 102 that receives the user data 104. The system 400 also includes an advertisement data receiver component 402 that can receive advertising information 403. For instance, the advertising information 403 may include information pertaining to which keywords are bid on by advertisers, an amount that is bid for advertisements with respect to various keywords, click-through rates for various advertisements, bid amounts for keywords used to display advertisements, number of times that advertisements have been displayed to one or more users, and other information related to advertising. In an example, the advertisement data receiver component 402 may receive advertising information (such as the advertising information 403) from one or more advertisers. In another example, the advertisement data receiver component 402 may receive advertisement information from a search engine.

The profile generator component 106 receives a subset of the user data 104 and a subset of the advertising information and generates the user profile 108 based at least in part thereon. As described above, the user profile 108 includes a plurality of keywords that may be individually assigned scores, wherein a score assigned to a keyword can be indicative of a probability that an advertisement corresponding to the keyword will be monetized (e.g., selected by the user and resulting in generated revenue).

The system 400 additionally includes an advertising component 404 that analyzes the user profile 108 and serves an advertisement 406 to the user based at least in part upon content of the user profile 108. Pursuant to an example, a user that corresponds to the user profile 108 may initiate a search session (e.g., by directing a browser to a search engine). The advertising component 404 can analyze the user profile 108 and serve an advertisement to the user based at least in part upon contents of the user profile 108. For instance, the advertising component 404 can review the user profile 108 and determine that the user is most likely to select an advertisement that corresponds to a keyword (e.g., a keyword in the user profile 108 that has been assigned the highest score). The advertising component 108 can serve an advertisement to the user that corresponds to the keyword prior to the user proffering a query to the search engine, or as a contextual (non-search) advertisement on any webpage.

In a detailed example, the user profile 108 may include a keyword “blue jeans”, and such keyword may be assigned a relatively high score. Accordingly, the user may be interested in clothing products in general, and blue jeans in particular. A retailer that sells blue jeans may wish to advertise to the user due to interest of the user in blue jeans—accordingly, the advertising component 404 can serve an advertisement pertaining to blue jeans to the user.

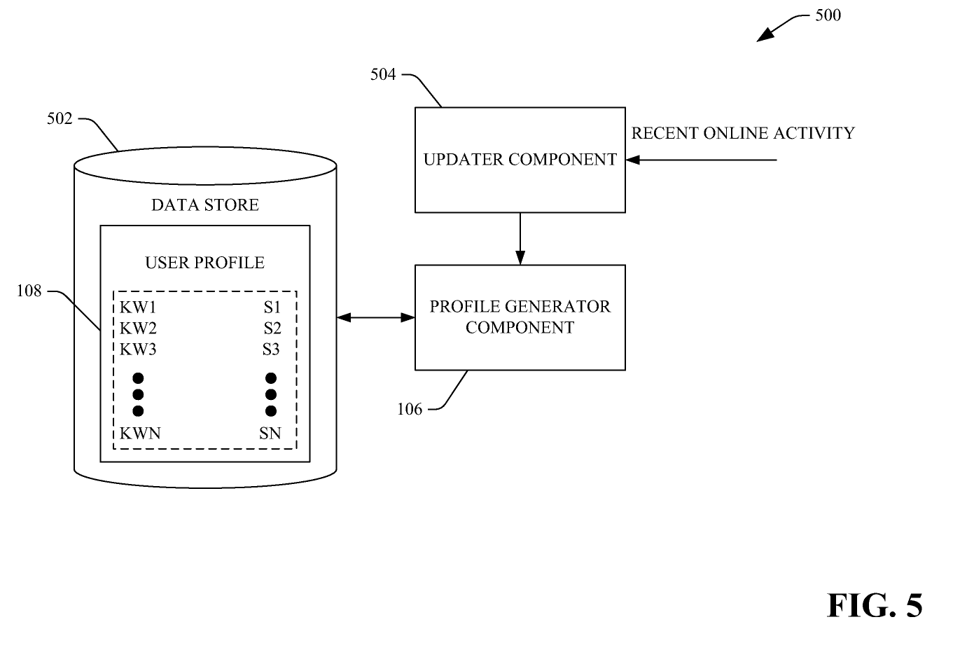

Now turning to FIG. 5, an example system 500 that facilitates updating an existing user profile based on recent online and/or offline activity of a user is illustrated. The system 500 includes a data store 502 that retains the user profile 108. The data store 502 may be an online data store, such as a data store corresponding to a search engine. In another example, the data store 502 may be a data store that is on a client device. In another example, the data store 502 may be a distributed data store with separate components on multiple devices. Retaining the user profile 108 on a client device may alleviate data privacy concerns of some users. For instance, the profile 108 may only be accessed upon express authorization from a user.

The system 500 further includes an updater component 504 that receives recent online and/or offline activity of the user, wherein the recent online and/or offline activity may be activity undertaken by the user after the user profile 108 was generated or last updated. For instance, recent activity of a user may indicate that interests of the user have altered, and therefore it may be desirable to alter the contents of the user profile 108 to reflect the change in interests of the user. The recent activity of the user may be received by the profile generator component 106, and the profile generator component 106 can access the user profile 108 from the data store 502. The profile generator component 106 can analyze contents of the user profile 108 and update such contents based at least in part upon the recent online activity of the user. For instance, the profile generator component 106 can add or remove keywords from the user profile 108. In another example, the profile generator component 106 can modify scores assigned to keywords based at least in part upon the recent activity.

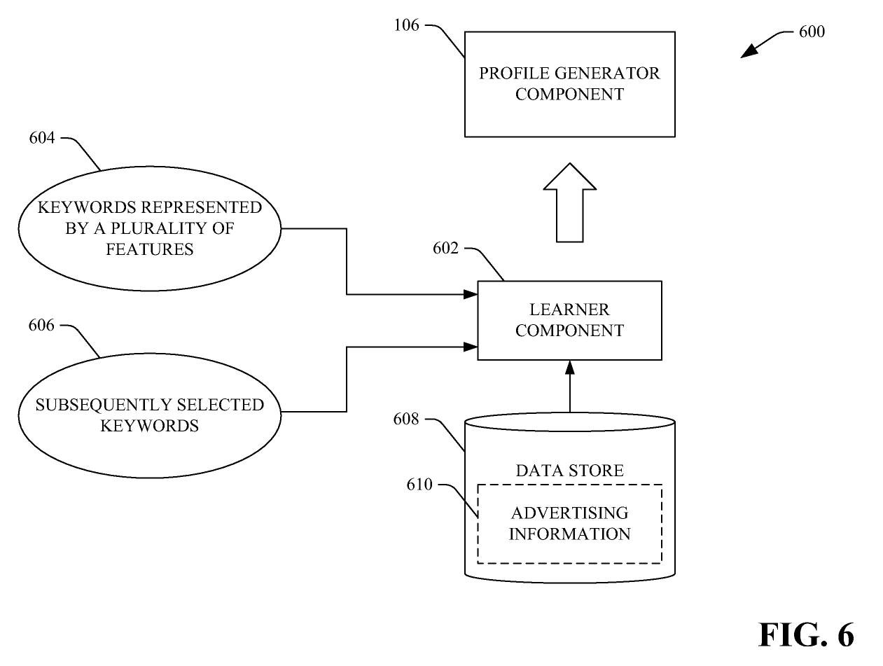

Now referring to FIG. 6, an example system 600 that facilitates outputting a machine-learned algorithm for utilization in connection with targeted advertising is illustrated. The system 600 includes a learner component 602 that outputs a machine-learned function that can be used by the profile generator component 106 to generate a user profile for utilization in connection with targeted advertising. To facilitate output of such a function, the learner component 602 can receive a plurality of candidate keywords 604, wherein each of the plurality of candidate keywords are represented by one or more features. The candidate keywords 604 received by the learner component 602 may include keywords obtained from logs of online activity of a user. Furthermore, the candidate keywords 604 may include keywords that are related to the keywords obtained from the logs of online activity of the user. Determining keywords from logs and determining related keywords has been described in detail above.

The learner component 602 can also receive subsequently selected keywords 606. More specifically, the candidate keywords 604 may relate to user activity in a data log that occurred prior to a particular time Tₛ. The subsequently selected keywords 606 may relate to activity of the user in the data log that occurred after the time Tₛ. Accordingly, the subsequently selected keywords 606 are indicative of future interests of the user after time Tₛ.

More specifically, the learner component 602 can use supervised machine learning methods to learn a function that combines computed features of keywords into a single score that, for instance, is indicative of a probability that an advertisement corresponding to a keyword will be monetized. Supervised machine learning methods can learn (approximate) a function S that maps input in some form (e.g., a set of keywords, where each keyword is represented by feature values) to an output (e.g., a most desirable set of keywords that represent future user interests that correspond to optimal advertising revenue).

The learning component 602 can rely on training data to learn the function S (e.g., the candidate keywords 604 and subsequent keyword selections 606). In the example system 600, as indicated above, the training data can be obtained from past user behavior that is separated based upon some intermediate time into “observations” that include behavior before the time and “best predictions” computed on behavior after the time, wherein “best” may mean, for example, most monetizable keywords. The learner component 602 can learn the function S that produces a set closest to “best predictions” from “observations.”

The learner component 602 may use any suitable learning mechanisms in connection with learning the function S. For instance, the learner component 602 may use maximum-margin methods, probabilistic models, regression trees, and/or the like. Furthermore, the learner component 602 can output a function based upon a variety of learning objectives. For instance, the system 600 may include a data store 608 that retains advertising information 610, which may include clicks on advertisements by the user and/or several users. The learner component 602 may be constructed to produce a function S that prefers keywords likely to be clicked in the future and produce maximum revenue. In another example, the learner component 602 may be configured to output a function S that generates predictions that correspond to the most salient interests of a user. In addition, the learner component 602 can combine multiple objectives.

The learner component 602 may include or utilize different learning methods depending on a type of scoring function that is desirably learned. Some scoring functions operate on multiple keywords to produce an entire set of keywords at once. To learn such functions, the learner component 602 can employ structured learning algorithms. In a different example, a scoring function can operate on individual keywords assigned thereto and output real-valued scores. This scoring function can be learned using standard learners that predict a single value based on keyword features.

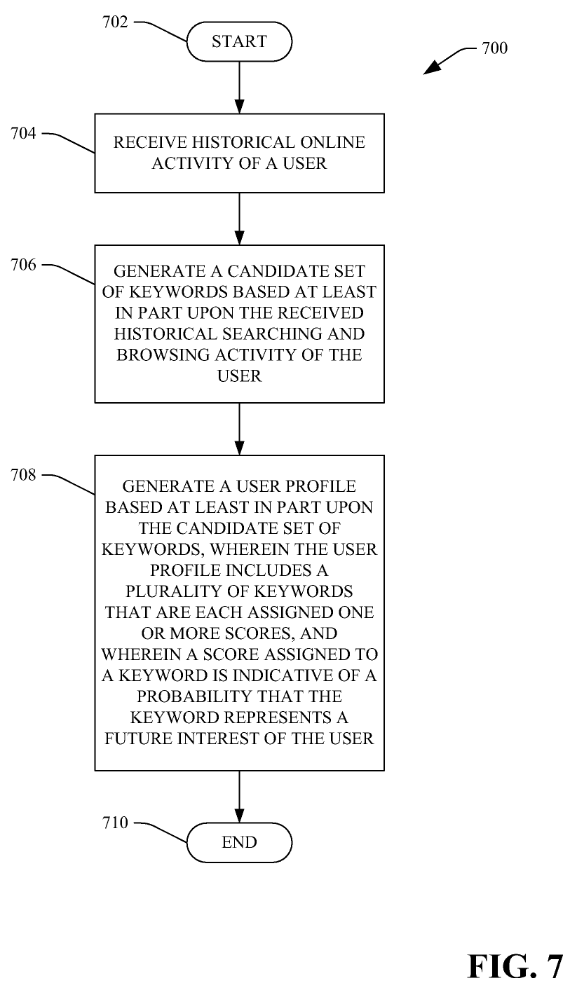

With reference now to FIGS. 7-11, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. Further, it is to be understood that at least some of the acts may be supplemented by functionality, acts, and/or features of the systems/components described above.

Referring specifically to FIG. 7, an example methodology 700 generating a user profile is illustrated. The methodology 700 starts at 702, and at 704 historical online activity of a user is received. For instance, the historical online activity of the user may be included in a search log.

At 706, a candidate set of keywords is generated based at least in part upon the received historical online activity of the user. As described above, the candidate set of keywords may include keywords in a log of searching and browsing activity of a user, as well as keywords related to such keywords.

At 708, a user profile is generated based at least in part upon the candidate set of keywords. The user profile may include a plurality of keywords that are each individually assigned one or more scores. For example, a score assigned to a keyword can be indicative of a probability that the keyword represents future interests of the user. In another example, a score assigned to a keyword can be indicative of a probability that an advertisement corresponding to the keyword will be monetized.

Pursuant to an example, content of a user profile, including scores assigned to keywords, may be dependent on the current context of a user. For instance, if the user is determined to be at work the user profile may include a first set of keywords, while if the user is determined to be at home the user profile may include a second set of keywords. In another example, scores assigned to keywords may alter depending on context corresponding to the user. For instance, scores assigned to keywords in the profile may depend upon user location, time of day, amount of time between a current search session and a previous search session, weather conditions, and/or the like. The methodology 700 completes at 710.

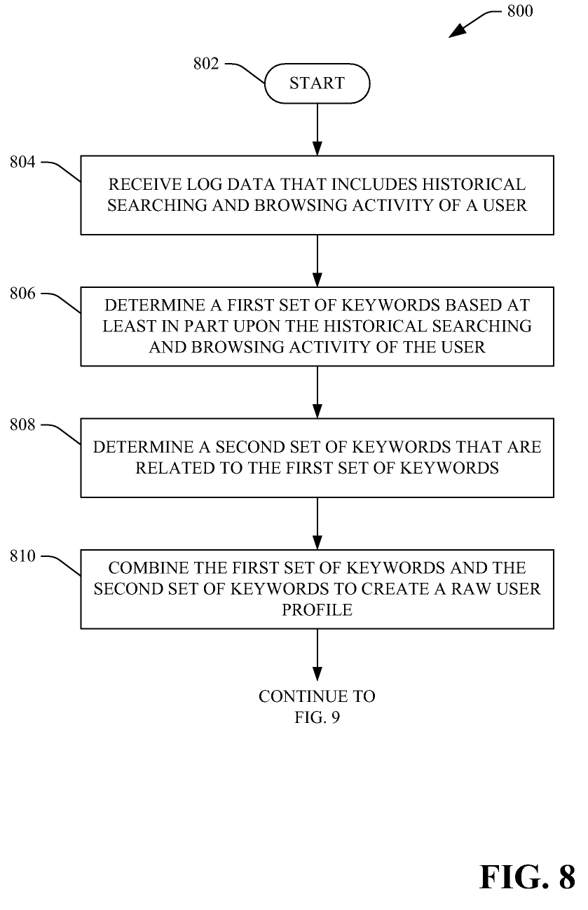

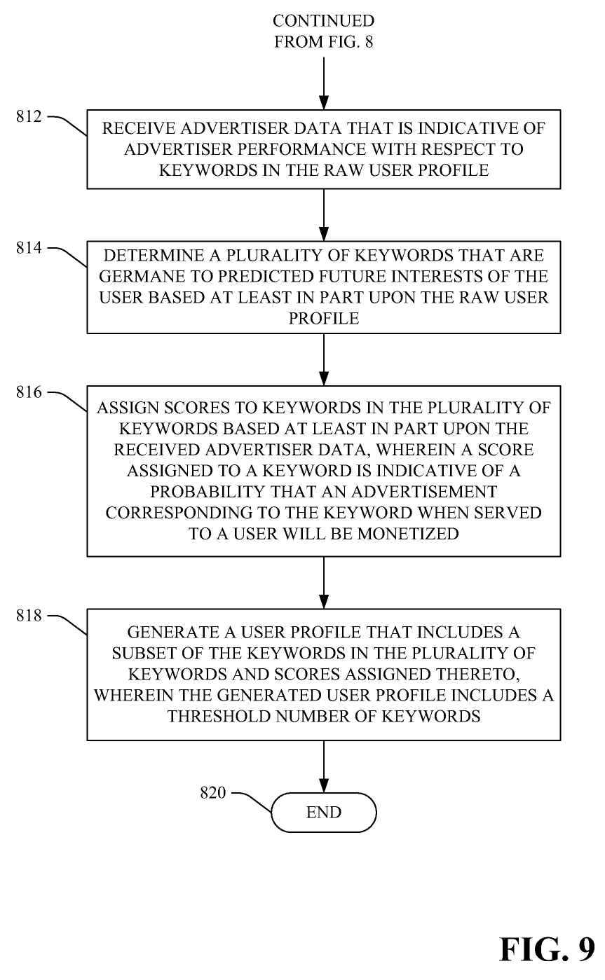

Turning now to FIGS. 8 and 9, a methodology 800 that facilitates generating a user profile for employment in connection with targeted advertising is illustrated. The methodology 800 starts at 802, and at 804 log data is received that includes historical searching and browsing activity of a user. For instance, the log data may include search engine logs.

At 806, a first set of keywords is determined based at least in part upon the historical searching and browsing activity of the user. At 808, a second set of keywords is determined, wherein the keywords in the second set of keywords are related to keywords in the first set of keywords.

At 810, the first set of keywords and the second set of keywords are combined to create a raw user profile. In other words, the raw user profile includes the first set of keywords and the second set of keywords. At 812, advertiser data that is indicative of advertiser performance with respect to keywords in the raw user profile is received. For instance, data relating to which keywords are bid upon by advertisers, how often advertisements corresponding to certain keywords are monetized, and other advertiser data may be received at 812.

At 814, a plurality of keywords that are germane to predicted future interests of the user are determined based at least in part upon the raw user profile. The plurality of keywords determined at 814 may include keywords that are in the raw user profile as well as keywords that are not in the raw user profile. In another example, the plurality of keywords determined at 814 may only include keywords that are in the raw user profile.

At 816, scores are assigned to each of the plurality of keywords determined at 814, wherein the scores are based at least in part upon the received advertiser data. A score assigned to a keyword can be indicative of a probability that an advertisement corresponding to the keyword will be monetized when an advertisement is served to the user. At 818, a user profile is generated, wherein the user profile includes a subset of the keywords determined at 814 and scores assigned thereto. Pursuant to an example, the generated user profile can include a threshold number of keywords. For instance, the generated user profile may be limited to ten keywords. In another example, the generated user profile may be limited to fifteen keywords. In yet another example, the generated user profile may be limited to a hundred keywords. The threshold may also be set based on scores assigned to keywords. For example, the generated user profile may be limited to keywords with a score above or below a certain value or within a certain range of values. The methodology 800 completes at 820.

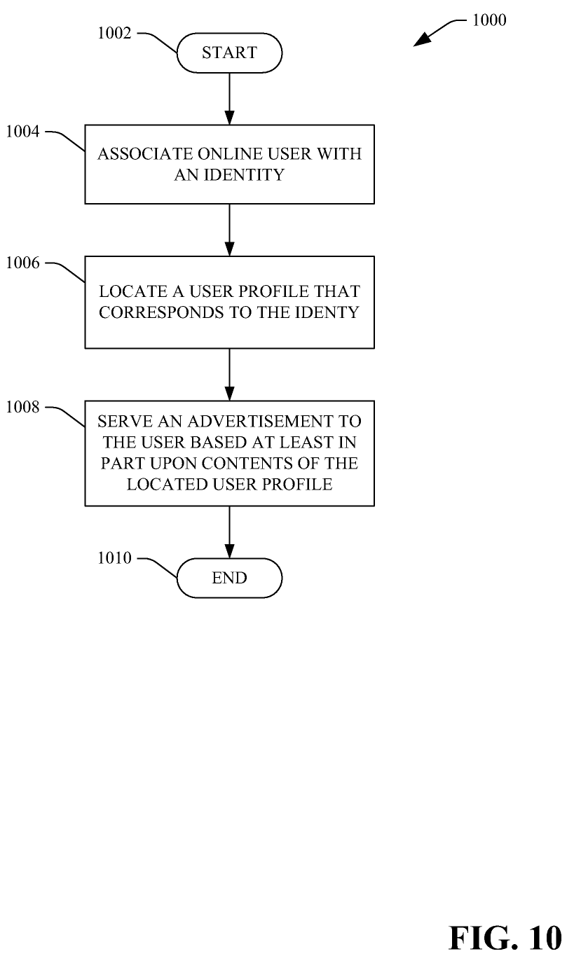

With reference now to FIG. 10, an example methodology 1000 for obtaining searching and browsing data with respect to a user is illustrated. The methodology 1000 starts at 1002, and at 1004 an online user is associated with an identity. The identity may be established from an IP address, login information, cookies, and/or the like. The identity may be tied to an individual or a group of individuals. At 1006, a user profile that corresponds to the identity is located. For instance, an online data store can be searched for the user profile. At 1008, an advertisement is served to the user based at least in part upon contents of the located user profile. The methodology 1000 then completes at 1010.

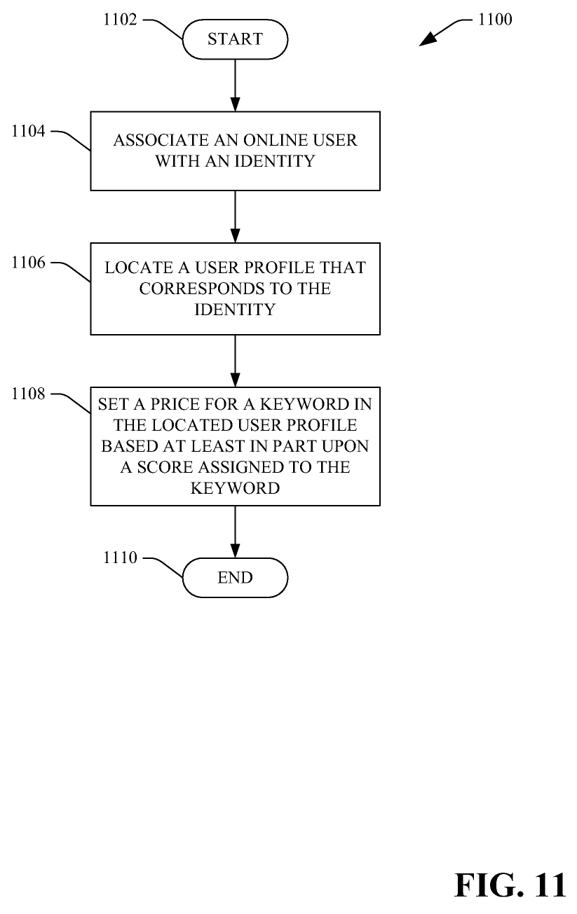

With reference now to FIG. 11, an example methodology 1100 that facilitates setting a price for a keyword is illustrated. The methodology 1100 starts at 1102, and at 1104 an online user is associated with an identity. For instance, an identity of an online user may be determined. In another example, the identity may be associated with a set of users At 1106, a user profile that corresponds to the identity is located (e.g., in an online data store). The user profile may include a plurality of keywords and scores assigned to such keywords, wherein a score assigned to a keyword may be indicative of a probability that a user corresponding to the identity will select an advertisement corresponding to the keyword. At 1108, a price is set for a keyword in the user profile based at least in part upon a score assigned to the keyword. For instance, if the score indicates that the user is likely to select an advertisement corresponding to the keyword, then a price for a keyword can be set as being higher than other keywords that have lower scores. The methodology 1100 completes at 1110.

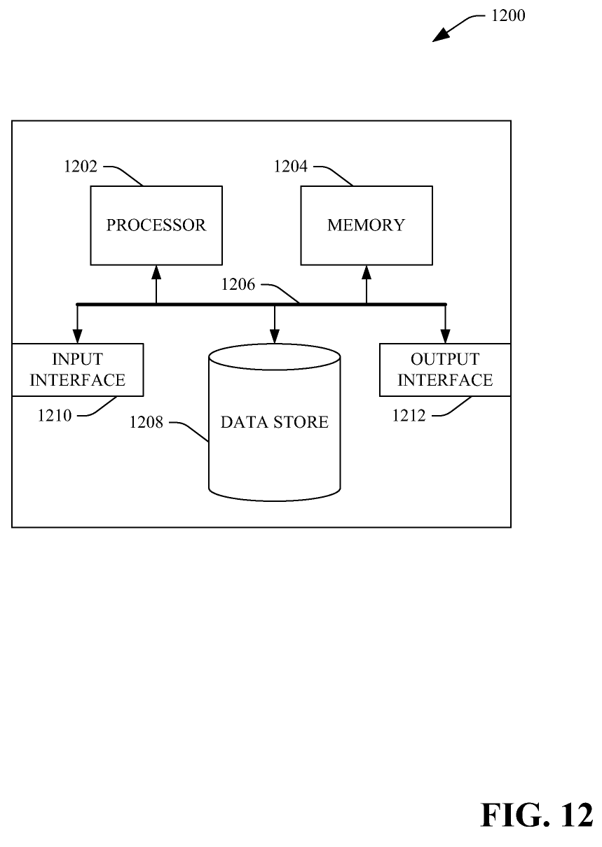

Now referring to FIG. 12, a high-level illustration of an example computing device 1200 that can be used in accordance with the systems and methodologies disclosed herein is illustrated. For instance, the computing device 1200 may be used in connection with a web-based search system, such as a search engine. In another example, the computing device 1200 may be used in connection with a targeted advertising system. Accordingly, the computing device 1200 may be a server system or be included within a server system. In another example, the computing device 1200 may be a client device or be included in a client device, such as a desktop computer, a laptop computer, a personal digital assistant, and the like. The computing device 1200 includes at least one processor 1202 that executes instructions that are stored in a memory 1204. The instructions may be, for instance, instructions for implementing functionality described as being carried out by one or more components discussed above or instructions for implementing one or more of the methods described above. The processor 1202 may access the memory by way of a system bus 1206. In addition to storing executable instructions, the memory 1204 may also store keywords, user profiles, scores assigned to user profiles, etc.

The computing device 1200 additionally includes a data store 1208 that is accessible by the processor 1202 by way of the system bus 1206. The data store 1208 may include executable instructions, user profiles, raw user profiles, keywords, scores, etc. The computing device 1200 also includes an input interface 1210 that allows users or external devices to communicate with the computing device 1200. For instance, the input interface 1210 may be used to receive instructions from an external computer device, queries from a user, etc. The computing device 1200 also includes an output interface 1212 that interfaces the computing device 1200 with one or more external devices or allows information to be provided to a user. For example, the computing device 1200 may display images, search results, advertisements, or the like by way of the output interface 1212.

Additionally, while illustrated as a single system, it is to be understood that the computing device 1200 may be a distributed system. Thus, for instance, several devices may be in communication by way of a network connection and may collectively perform tasks described as being performed by the computing device 1400.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A system that comprises the following computer-executable components:
a receiver component that receives user data; and
a profile generator component that generates a user profile based at least in part upon a subset of the user data, wherein the user profile includes a plurality of keywords, wherein at least one keyword in the plurality of keywords is assigned a score that is indicative of at least one of a probability that an advertisement corresponding to the keyword will be monetized, revenue expected to be received from an advertiser, or a probability that a user will be interested in a topic corresponding to the keyword in the future.

2. The system of claim 1, wherein the user data includes queries proffered by the user, web page visited by the user, and advertisements selected by the user.

3. The system of claim 2, further comprising a keyword determiner component that determines a first set of keywords from content of the user data.

4. The system of claim 3, further comprising a related keyword determiner component that receives the first set of keywords and determines a second set of keywords that are related to the first set of keywords, wherein the user data includes the first set of keywords.

5. The system of claim 1, further comprising:
an identifier component that associates the user with an identity; and
an activity tracker component that tracks online activity of the user and adds tracked activity to the user data.

6. The system of claim 1, further comprising an advertisement data receiver component that receives advertising information, wherein the advertising information includes click-through rate data of an advertisement with respect to one or more keywords used to display the advertisement, bid amounts for keywords used to display the advertisement, and a number of times that the advertisement has been displayed, and wherein the profile generator component receives the advertising information and generates the user profile based at least in part upon the advertising information.

7. The system of claim 1, wherein the user profile includes keywords not previously employed by the user.

8. The system of claim 1, further comprising an advertising component that outputs an advertisement based at least in part upon contents of the user profile.

9. The system of claim 1, further comprising an updater component that provides the profile generator component with recent online user activity, wherein the profile generator component receives the recent online user activity and updates the user profile based at least in part thereon.

10. The system of claim 1, wherein the profile generator component selects a keyword to be placed in the user profile based at least in part upon recency and frequency of occurrence of the keyword in the user data.

11. The system of claim 1, wherein the profile generator component infers a keyword that is expected to be of interest to the user at a future point in time, wherein the profile generator component infers the keyword based at least in part upon the user data.

12. The system of claim 1, wherein the user profile includes a threshold number of keywords.

13. A method comprising the following computer-executable acts:
generating a candidate set of keywords based at least in part upon historical online activity of a user; and
generating a user profile based at least in part upon the candidate set of keywords, wherein the user profile includes a plurality of keywords that are each assigned one or more scores, wherein a score assigned to a keyword is indicative of a probability that the keyword represents a predicted future interest of the user.

14. The method of claim 13, wherein generating the candidate set of keywords comprises:
receiving of the historic online activity of the user in the form of multiple keywords; and
determining keywords that are related to the multiple keywords and adding the keywords to the multiple keywords.

15. The method of claim 1 wherein the historic online activity of the user includes queries proffered by the user, web page visited by the user, and advertisements selected by the user.

16. The method of claim 13, further comprising:
receiving advertising data pertaining to revenue generated by particular advertisements; and
generating the user profile based at least in part upon the advertising data.

17. The method of claim 13, further comprising serving an advertisement to the user based at least in part upon contents of the user profile.

18. The method of claim 13, further comprising setting a price for a keyword in the user profile based at least in part upon a score assigned to the keyword.

19. The method of claim 13, further comprising updating the user profile based at least in part upon online activity of the user.

20. A computer readable medium comprising instructions that, when executed by a processor, perform the following acts:
receive log data that includes historic searching and browsing activities of a user;
determine a first set of keywords based at least in part upon the searching and browsing activities of the user;
determine a second set of keywords that are related to the first set of keywords;
combine the first set of keywords and the second set of keywords to create a raw user profile;
receive advertiser data that is indicative of advertiser performance with respect to keywords in the raw user profile;
determine a plurality of keywords that are germane to future interests of the user based at least in part upon the raw user profile;
assign scores to keywords in the plurality of keywords based at least in part upon the received advertiser data, wherein a score assigned to a keyword in the plurality of keywords is indicative of a probability that an advertisement corresponding to the keywords will be monetized when served to the user; and
generate a user profile that includes a subset of the keywords in the plurality of keywords and scores assigned thereto, wherein the generated user profile includes a threshold number of keywords.
